(19) United States
(12) Patent Application Publication
(10) Pub. No.: US 2018/0122422 A1
(43) Pub. Date: May 3, 2018

(54) MULTIMEDIA CREATION, PRODUCTION, AND PRESENTATION BASED ON SENSOR-DRIVEN EVENTS

(71) Applicant: LR Acquisition, LLC, New York, NY (US)

(72) Inventors: James W. Allison, Carmel Valley, CA (US); Henry W. Bradlow, San Francisco, CA (US); Gillian C. Langor, Oakland, CA (US); Antoine Balaresque, Sausalito, CA (US)

(73) Assignee: LR Acquisition, LLC, New York, NY (US)

(21) Appl. No.: 15/795,797

(22) Filed: Oct. 27, 2017

Related U.S. Application Data
(60) Provisional application No. 62/416,600, filed on Nov. 2, 2016.

(51) Int. Cl. G11B 27/031; G06K 9/00; G11B 27/34; H04N 21/435; H04N 21/472; H04N 21/45; H04N 21/2743

(52) U.S. Cl. CPC G11B 27/031; G06K 9/00751; G11B 27/34; G06K 2009/00738; H04N 21/47205; H04N 21/4516; H04N 21/2743; H04N 21/435

(57) ABSTRACT

Introduced herein are techniques for improving media content production and consumption by utilizing metadata associated with the relevant media content. More specifically, systems and techniques are introduced herein for automatically producing media content (e.g., a video composition) using several inputs uploaded by a filming device (e.g., an unmanned aerial vehicle (UAV) copter or action camera), an operator device, and/or some other computing device. Some or all of these devices may include non-visual sensors that generate sensor data. Interesting segments of raw video recorded by the filming device can be formed into a video composition based on events detected within the non-visual sensor data that are indicative of interesting real world events. For example, substantial variations or significant absolute values in elevation, pressure, acceleration, etc., may be used to identify segments of raw video that are likely to be of interest to a viewer.

### CROSS-REFERENCE TO RELATED APPLICATION

This application claims priority to U.S. Provisional Patent Application No. 62/416,600, filed Nov. 2, 2016, the entire contents of which are herein incorporated by reference in their entirety.

### RELATED FIELD

At least one embodiment of this disclosure relates generally to techniques for filming, producing, editing, and/or presenting media content based on data created by one or more visual and/or non-visual sensors.

### BACKGROUND

Video production is the process of creating video by capturing moving images, and then creating combinations and reductions of parts of the video in live production and post-production. Finished video productions range in size and can include, for example, television programs, television commercials, corporate videos, event videos, etc. The type of recording device used to capture video often changes based on the intended quality of the finished video production. For example, one individual may use a mobile phone to record a short video clip that will be uploaded to social media (e.g., Facebook or Instagram), while another individual may use a multiple-camera setup to shoot a professional-grade video clip.

Video editing software is often used to handle the post-production video editing of digital video sequences. Video editing software typically offers a range of tools for trimming, splicing, cutting, and arranging video recordings (also referred to as “video clips”) across a timeline. Examples of video editing software include Adobe Premiere Pro, Final Cut Pro X, iMovie, etc. However, video editing software may be difficult to use, particularly for those individuals who capture video using a personal computing device (e.g., a mobile phone) and only intend to upload the video to social media or retain it for personal use.

### BRIEF DESCRIPTION OF THE DRAWINGS

Various objects, features, and characteristics will become apparent to those skilled in the art from a study of the Detailed Description in conjunction with the appended claims and drawings, all of which form a part of this specification. While the accompanying drawings include illustrations of various embodiments, the drawings are not intended to limit the claimed subject matter.

FIG. 1 depicts a diagram of an environment that includes a network-accessible platform that is communicatively coupled to a filming device, an operator device, and/or a computing device associated with a user of the filming device.

FIG. 2 depicts the phases of media development, including acquisition (e.g., filming or recording), production, and presentation/consumption.

FIG. 3 depicts several steps that are conventionally performed during production (i.e., stage 2 as shown in FIG. 2).

FIG. 4 depicts how the techniques introduced herein can affect the phases of media development shown in in FIG. 3.

FIG. 5 depicts a flow diagram of a process for automatically producing media content (e.g., a video composition) using several inputs, in accordance with various embodiments.

FIG. 6 depicts one example of a process for automatically producing media content (e.g., a video composition) using inputs from several distinct computing devices, in accordance with various embodiments.

FIG. 7 is a block diagram of an example of a computing device, which may represent one or more computing device or servers described herein, in accordance with various embodiments.

The figures depict various embodiments described throughout the Detailed Description for the purposes of illustration only. While specific embodiments have been shown by way of example in the drawings and are described in detail below, one skilled in the art will readily recognize the subject matter is amenable to various modifications and alternative forms without departing from the principles of the invention described herein. Accordingly, the claimed subject matter is intended to cover all modifications, equivalents, and alternatives falling within the scope of the invention as defined by the appended claims.

### DETAILED DESCRIPTION

Introduced herein are systems and techniques for improving media content production and consumption by utilizing metadata associated with the relevant media content. The metadata can include, for example, sensor data created by a visual sensor (e.g., a camera or light sensor) and/or a non-visual sensor (e.g., an accelerometer, gyroscope, magnetometer, barometer, global positioning system module, or inertial measurement unit) that is connected to a filming device, an operator device for controlling the filming device, or some other computing device associated with a user of the filming device.

Such techniques have several applications, including:
Filming—Sensor-driven events can be used to modify certain characteristics of the filming device, such as the focal depth, focal position, recording resolution, position (e.g., altitude of an unmanned aerial vehicle (UAV) copter), orientation, movement speed, or some combination thereof.
Production—Acquisition of raw media typically requires high bandwidth channels. However, automatically identifying interesting segments of raw media (e.g., video or audio) based on sensor-driven events can improve the efficiency of editing, composition, and/or production.
Presentation—The media editing/composing/producing techniques described herein provide a format that enables delivery of more dynamic and/or personalized media content. This can be accomplished by using sensor data to match other media streams (e.g., video and audio) that relate to the viewer. Embodiments may also utilize other viewer information, such as the time of day of viewing, the time since the media content was created, the viewer's social connection to the content creator, the current or previous location of the viewer (e.g., was the viewer present when the media content was created), etc.
Consumption—Viewers may be able to guide the consumption of media content by providing feedback in real time. For example, a viewer (who may also be an editor of media content) may provide feedback to guide a dynamic viewing experience enabled by several content streams that run in parallel (e.g., a video stream uploaded by a filming device and a sensor data stream uploaded by another computing device). As another example, a viewer may be able to access more detailed information/content from a single content stream if the viewer decides that content stream includes particularly interesting real-world events.

One skilled in the art will recognize that the techniques described herein can be implemented independent of the type of filming device used to capture raw video. For example, such techniques could be applied to an unmanned aerial vehicle (UAV) copter, an action camera (e.g., a GoPro camera (or Garmin VIRB), a mobile phone, tablet, or personal computer (e.g., desktop or laptop computer). More specifically, a user of an action camera may wear a tracker (also referred to more simply as a “computing device” or an “operator device”) that generates sensor data, which can be used to identify interesting segments of raw video captured by the action camera.

Video compositions (and other media content) can be created using different “composition recipes” that specify an appropriate style or mood and that allow video content to be timed to match audio content (e.g., music and sound effects). While the “composition recipes” allow videos to be automatically created (e.g., by a network-accessible platform or a computing device, such as a mobile phone, tablet, or personal computer), some embodiments enable additional levels of user input. For example, an editor may be able to reorder or discard certain segments, select different raw video clips, and use video editing tools to modify color, warping, stabilization, etc.

Also introduced herein are techniques for creating video composition templates that include interesting segments of video and/or timestamps, and then storing the video composition templates to delay the final composition of a video composition from a template until presentation. This enables the final composition of the video to be as personalized as possible using, for example, additional media streams that are selected based on metadata (e.g., sensor data) and viewer interests/characteristics.

Filming characteristics or parameters of the filming device can also be modified based on sensor-driven events. For example, sensor measurements may prompt changes to be made to the positioning, orientation, or movement pattern of the filming device. As another example, sensor measurements may cause the filming device to modify its filming technique (e.g., by changing the resolution, focal point, etc.). Accordingly, the filming device (or some other computing device) may continually or periodically monitor the sensor measurements to determine whether they exceed an upper threshold value, fall below a lower threshold value, or exceed a certain variation in a specified time period.

### Terminology

Brief definitions of terms, abbreviations, and phrases used throughout this disclosure are given below.

As used herein, the terms “connected,” “coupled,” or any variant thereof, means any connection or coupling, either direct or indirect, between two or more elements; the coupling of connection between the elements can be physical, logical, or a combination thereof. For example, two components may be coupled directly to one another or via one or more intermediary channels or components. Additionally, the words “herein,” “above,” “below,” and words of similar import shall refer to this application as a whole and not to any particular portions of this application.

### System Topology Overview

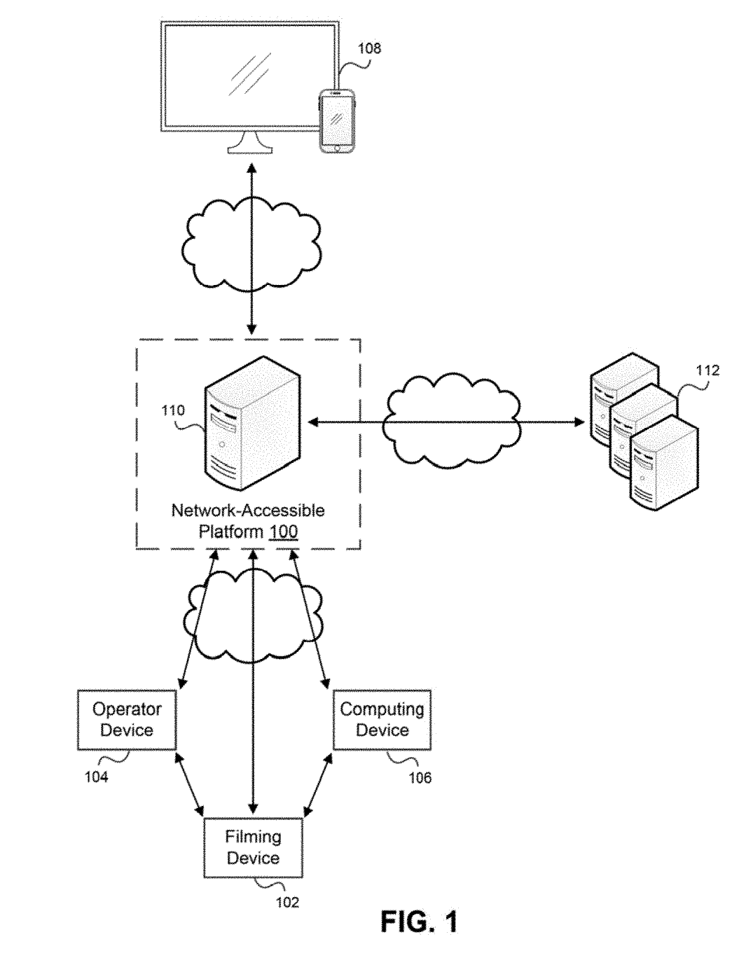

FIG. 1 depicts a diagram of an environment that includes a network-accessible platform 100 that is communicatively coupled to a filming device 102, an operator device 104, and/or a computing device 106 associated with a user of the filming device 102. However, in some embodiments the network-accessible platform 100 need not be connected to the Internet (or some other network). For example, although FIG. 1 depicts a network-accessible platform, all of the techniques described herein could also be performed on the filming device 102, operator device 104, and/or computing device 106. Thus, media composition/editing may be performed on the filming device 102 rather than via a cloud-based interface.

Examples of the filming device 102 include, for example, an action camera, an unmanned aerial vehicle (UAV) copter, a mobile phone, tablet, or personal computer (e.g., desktop or laptop computer). Examples of the operator device 104 include a stand-alone or wearable remote control for controlling the filming device 102. Examples of the computing device 106 include, for example, a smartwatch (e.g., an Apple Watch or Pebble), an activity/fitness tracker (e.g., made by Fitbit, Garmin, or Jawbone), or a health tracker (e.g., a heart rate monitor).

Each of these devices can upload streams of data to the network-accessible platform 100, either directly or indirectly (e.g., via the filming device 102 or operator device 104, which may maintain a communication link with the network-accessible platform 100). The data streams can include video, audio, user-inputted remote controls, Global Positioning System (GPS) information (e.g., user speed, user path, or landmark-specific or location-specific information), inertial measurement unit (IMU) activity, flight state of filming device, voice commands, audio intensity, etc. For example, the filming device 102 may upload video and audio, while the computing device 106 may upload IMU activity and heart rate measurements. Consequently, the network-accessible platform 100 may receive parallel rich data streams from multiple sources simultaneously or sequentially.

The network-accessible platform 100 may also be communicatively coupled to an editing device 108 (e.g., a mobile phone, tablet, or personal computer) on which an editor views content recorded by the filming device 102, the operator device 104, and/or the computing device 106. The editor could be, for example, the same individual as the user of the filming device 102 (and, thus, the editing device 108 could be the same computing device as the filming device 102, the operator device 104 or the computing device 106). The network-accessible platform 100 is connected to one or more computer networks, which may include local area networks (LANs), wide area networks (WANs), metropolitan area networks (MANs), cellular networks, and/or the Internet.

Various system architectures could be used to build the network-accessible platform 100. Accordingly, the content may be viewable and editable by the editor using the editing device 108 through one or more of a web browser, software program, mobile application, and over-the-top (OTT) application. The network-accessible platform 100 may be executed by cloud computing services operated by, for example, Amazon Web Services (AWS) or a similar technology. Oftentimes, a host server 110 is responsible for supporting the network-accessible platform and generating interfaces (e.g., editing interfaces and compilation timelines) that can be used by the editor to produce media content (e.g., a video composition) using several different data streams as input. As further described below, some or all of the production/editing process may be automated by the network-accessible platform 100. For example, media content (e.g., a video) could be automatically produced by the network-accessible platform 100 based on events discovered within sensor data uploaded by the filming device 102, the operator device 104, and/or the computing device 106.

The host server 110 may be communicatively coupled (e.g., across a network) to one or more servers 112 (or other computing devices) that include media content and other assets (e.g., user information, computing device information, social media credentials). This information may be hosted on the host server 110, the server(s) 112, or distributed across both the host server 110 and the server(s) 112.

### Conventional Media Development

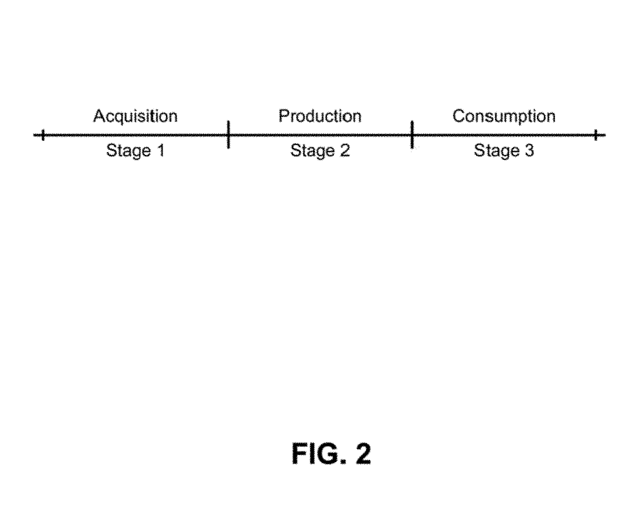

FIG. 2 depicts the phases of media development, including acquisition (e.g., filming or recording), production, and presentation/consumption. Media content is initially acquired (stage 1) by an individual. For example, video could be recorded by one or more filming devices (e.g., an action camera, UAV copter, or conventional video camera). Other types of media content, such as audio, may also be recorded by the filming device or another nearby device.

Production (stage 2) is the process of creating finished media content from combinations and reductions of parts of raw media. This can include the production of videos that range from professional-grade video clips to personal videos that will be uploaded to social media (e.g., Facebook or Instagram). Production (also referred to as the “media editing process”) is often performed in multiple stages (e.g., live production and post-production).

The finished media content can then be presented to one or more individuals and consumed (stage 3). For instance, the finished media content may be shared with individual(s) through one or more distribution channels, such as via social media, text messages, electronic mail (“e-mail”), or a web browser. Accordingly, in some embodiments the finished media content is converted into specific format(s) so that it is compatible with these distribution channel(s).

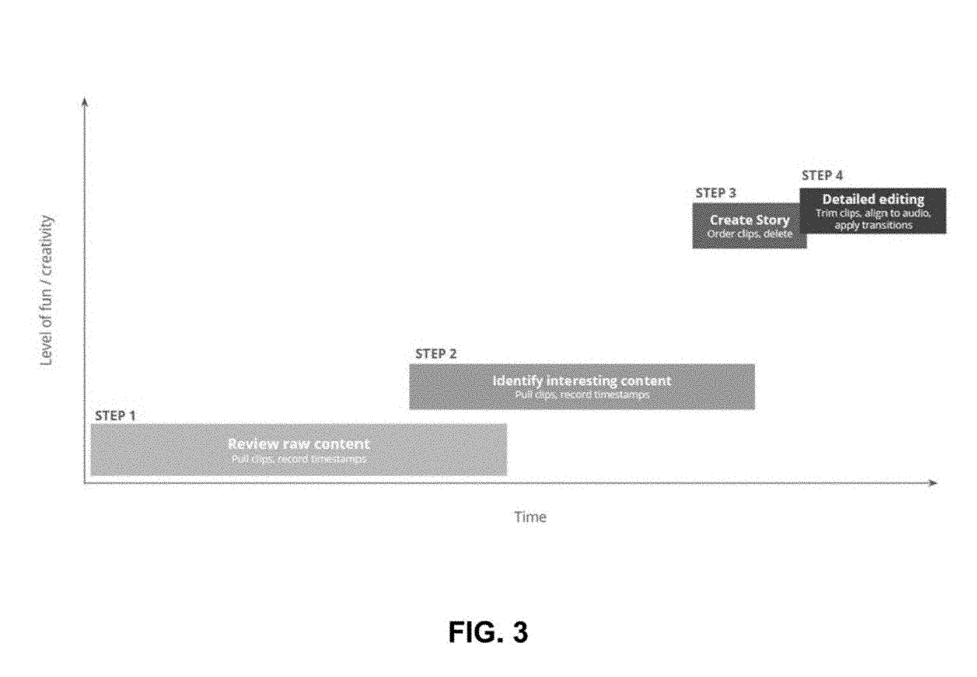

FIG. 3 depicts several steps that are conventionally performed during production (i.e., stage 2 as shown in FIG. 2). Raw media content is initially reviewed by an editor (step 1). For example, the editor may manually record timestamps within the raw media content, align the raw media content along a timeline, and create one or more clips from the raw media content.

The editor would then typically identify interesting segments of media content by reviewing each clip of raw media content (step 2). Conventional media editing platforms typically require that the editor flag or identify interesting segments in some manner, and then pull the interesting segments together in a given order (step 3). Said another way, the editor can form a “story” by arranging and combining segments of raw media content in a particular manner. The editor may also delete certain segments of raw media content when creating the finalized media content.

In some instances, the editor may also perform one or more detailed editing techniques (step 4). Such techniques include trimming raw media segments, aligning multiple types of raw media (e.g., audio and video that have been separately recorded), applying transitions and other special effects, etc.

### Multimedia Creation, Production, and Presentation

Introduced herein are systems and techniques for automatically producing media content (e.g., a video composition) using several inputs uploaded by one or more computing devices (e.g., filming device 102, operator device 104, and/or computing device 106 of FIG. 1). More specifically, production techniques based on sensor-driven events are described herein that allow media content to be automatically or semi-automatically created on behalf of a user of a filming device (e.g., a UAV copter or action camera). For example, interesting segments of raw video recorded by the filming device could be identified and formed into a video composition based on events that are detected within sensor data and are indicative of an interesting real-world event. The sensor data can be created by a non-visual sensor, such as an accelerometer, gyroscope, magnetometer, barometer, global positioning system module, inertial measurement unit (IMU), etc., that is connected to the filming device, an operator device for controlling the filming device, or another computing device associated with the user of the filming device. Sensor data could also be created by a visual sensor, such as a camera or light sensor. For example, events may be detected within sensor data based on significant changes between consecutive visual frames, large variations in ambient light intensity, pixel values or variations (e.g., between single pixels or groups of pixels), etc.

Video compositions (and other media content) can be created using different “composition recipes” that specify an appropriate style or mood and that allow video content to be timed to match audio content (e.g., music and sound effects). While the “composition recipes” allow videos to be automatically created (e.g., by network-accessible platform 100 of FIG. 1 or some other computing device, such as a mobile phone, tablet, or personal computer), some embodiments enable additional levels of user input. For example, an editor may be able to reorder or discard certain segments, select different raw video clips, and use video editing tools to modify color, warping, stabilization, etc.

As further described below, some embodiments also enable the “composition recipes” and “raw ingredients” (i.e., the content needed to complete the “composition recipes,” such as the timestamps, media segments, and raw input media) to be saved as a templated story that can be subsequently enhanced. For example, the templated story could be enabled at the time of presentation with social content (or other related content) that is appropriate for the consumer/viewer. Accordingly, sensor data streams could be used to dynamically improve acquisition, production, and presentation of (templated) media content.

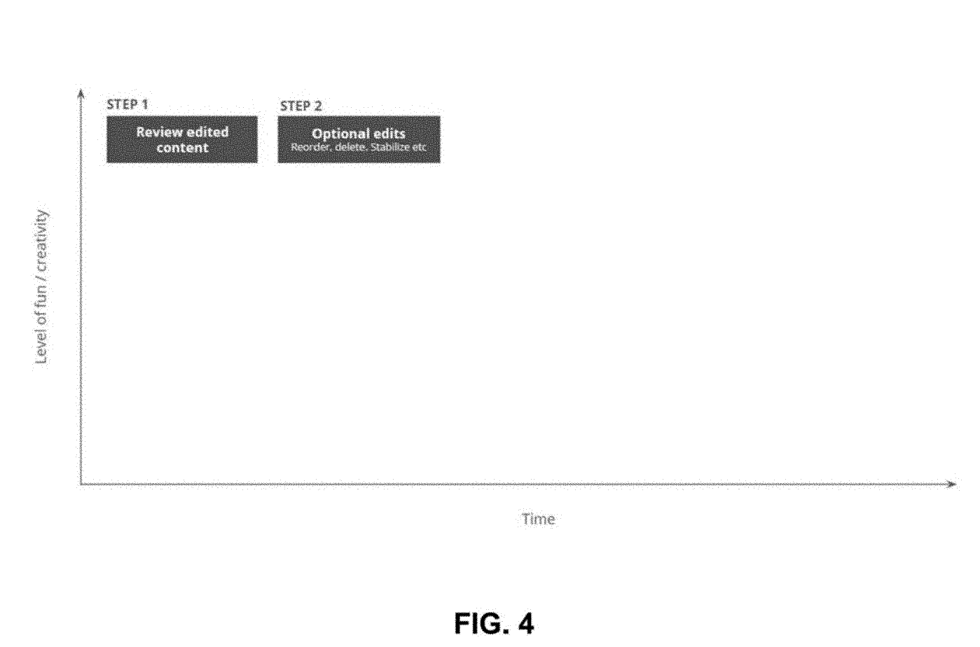

FIG. 4 depicts how the techniques introduced herein can affect the phases of media development shown in in FIG. 3. More specifically, the techniques introduced herein can be used to simply or eliminate user responsibilities during acquisition (e.g., filming or recording), production, and presentation/consumption. Rather than require an editor meticulously review raw media content and identify interesting segments, a network-accessible platform (e.g., network-accessible platform 100 of FIG. 1) or some other computing device can review/parse raw media content and temporally-aligned sensor data to automatically identify interesting segments of media content on behalf of a user.

Accordingly, the user can instead spend time reviewing edited media content (e.g., video compositions) created from automatically-identified segments of media content. In some instances, the user may also perform further editing of the edited media content. For example, the user may reorder or discard certain segments, or select different raw video clips. As another example, the user may decide to, use video editing tools to perform certain editing techniques and modify color, warping, stabilization, etc.

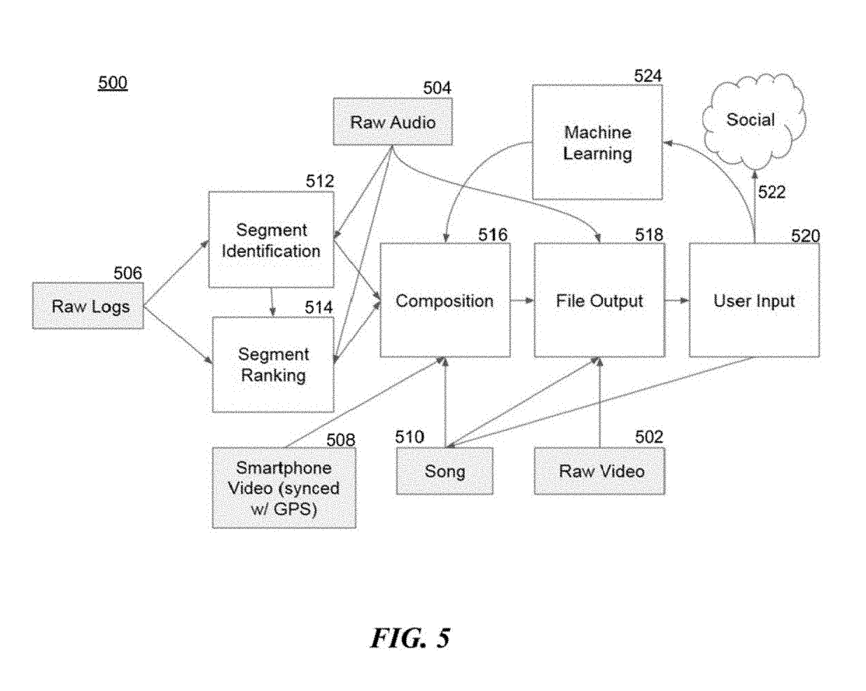

FIG. 5 depicts a flow diagram of a process 500 for automatically producing media content (e.g., a video composition) using several inputs, in accordance with various embodiments. The inputs can include, for example, raw video 502 and/or raw audio 504 uploaded by a filming device, an operator device, and/or some other computing device (e.g., filming device 102, operator device 104, and computing device 106 of FIG. 1). It may also be possible for the inputs (e.g., sensor data) to enable these devices to more efficiently index (and then search) captured media content and present identified segments to a user/editor in a stream. Consequently, the network requirements for uploading the identified segments in a long, high-resolution media stream can be significantly reduced. Said another way, among other benefits, the techniques described herein can be used to reduce the (wireless) network bandwidth required to communicate identified segments of media content between multiple network-connected computing devices (or between a computing device and the Internet).

Raw logs of sensor information 506 can also be uploaded by the filming device, operator device, and/or another computing device. For example, an action camera or a mobile phone may upload video 508 that is synced with Global Positioning System (GPS) information. Other information can also be uploaded to, or retrieved by, a network-accessible platform, including user-inputted remote controls, GPS information (e.g., user speed, user path), inertial measurement unit (IMU) activity, voice commands, audio intensity, etc. Certain information may be only be requested by the network-accessible platform in some embodiments (e.g., flight state of the filming device when the filming device is a UAV copter). Audio 510, such as songs and sound effects, could also be retrieved by the network-accessible platform (e.g., from server(s) 112 of FIG. 1) for incorporation into the automatically-produced media content.

The importance of each of these inputs can be ranked using one or more criteria. The criteria may be used to identify which input(s) should be used to automatically produce media content on behalf of the user. The criteria can include, for example, camera distance, user speed, camera speed, video stability, tracking accuracy, chronology, and deep learning.

More specifically, raw sensor data 506 uploaded to the network-accessible platform by the filming device, operator device, and/or other computing device can be used to automatically identify relevant segments of raw video 502 (step 512). Media content production and/or presentation may be based on sensor-driven or sensor-recognized events. Accordingly, the sensor(s) responsible for generating the raw sensor data 506 used to produce media content may not be housed within the filming device responsible for capturing the raw video 502. For example, interesting segments of raw video 502 can be identified based on large changes in acceleration as detected by an accelerometer or large changes in elevation as detected by a barometer. As noted above, the accelerometer and barometer may be connected to (or housed within) the filming device, operator device, and/or other computing device. One skilled in the art will recognize that while accelerometers and barometers have been used as examples, other sensors are can be (and often are) used. In some embodiments, the interesting segment(s) of raw video identified by the network-accessible platform are ranked using the criteria discussed above (step 514).

The network-accessible platform can then automatically create a video composition that includes at least some of the interesting segment(s) on behalf of the user of the filming device (step 516). For example, the video composition could be created by following different “composition recipes” that allow the style of the video composition to be tailored (e.g., to a certain mood or these) and timed to match certain music and other audio inputs (e.g., sound effects). After production of the video composition is completed, a media file (often a multimedia file) is output for further review and/or modification by the editor (step 518).

In some embodiments, one or more editors guide the production of the video composition by manually changing the “composition recipe” or selecting different audio files or video segments. Some embodiments also enable the editor(s) to take additional steps to modify the video composition (step 520). For example, the editor(s) may be able to reorder interesting segment(s), choose different raw video segments, and utilize video editing tools to modify color, warping, and stabilization.

After the editor(s) have finished making any desired modifications, the video composition is stabilized into its final form. In some embodiments, post-processing techniques are then used on the stabilized video composition, such as dewarping, color correction, etc. The final form of the video composition may be cut, recorded, and/or downscaled for easier sharing on social media (e.g., Facebook, Instagram, and YouTube) (step 522). For example, video compositions may naturally be downscaled to 720p based on a preference previously specified by the editor(s) or the owner/user of the filming device.

Additionally or alternatively, the network-accessible platform may be responsible for creating video composition templates that include interesting segments of the raw video 502 and/or timestamps, and then storing the video composition templates to delay the final composition of a video composition from a template until presentation. This enables the final composition of the video to be as personalized as possible using, for example, additional media streams that are selected based on metadata (e.g., sensor data) and viewer interests/characteristics (e.g., derived from social media).

As video compositions are produced, machine learning techniques can be implemented that allow the network-accessible platform to improve in its ability to acquire, produce, and/or present media content (step 524). For example, the network-accessible platform may analyze how different editors compare and rank interesting segment(s) (e.g., by determining why certain identified segments are not considered interesting, or by determining how certain non-identified segments that are considered interesting were missed) to help improve the algorithms used to identify and/or rank interesting segments of raw video using sensor data. Similarly, editor(s) can also reorder interesting segments of video compositions and remove undesired segments to better train the algorithms. Machine learning can be performed offline (e.g., where an editor compares multiple segments and indicates which one is most interesting) or online (e.g., where an editor manually recorders segments within a video composition and removes undesired clips). The results of both offline and online machine learning processes can be used to train a machine learning module executed by the network-accessible platform for ranking and/or composition ordering.

One skilled in the art will recognize that although the process 500 described herein is executed by a network-accessible platform, the same process could also be executed by another computing device, such as a mobile phone, tablet, or personal computer (e.g., laptop or desktop computer).

Moreover, unless contrary to physical possibility, it is envisioned that the steps described above may be performed in various sequences and combinations. For instance, an editor may accept or discard individual segments that are identified as interesting before the video composition is formed. Other steps could also be included in some embodiments.

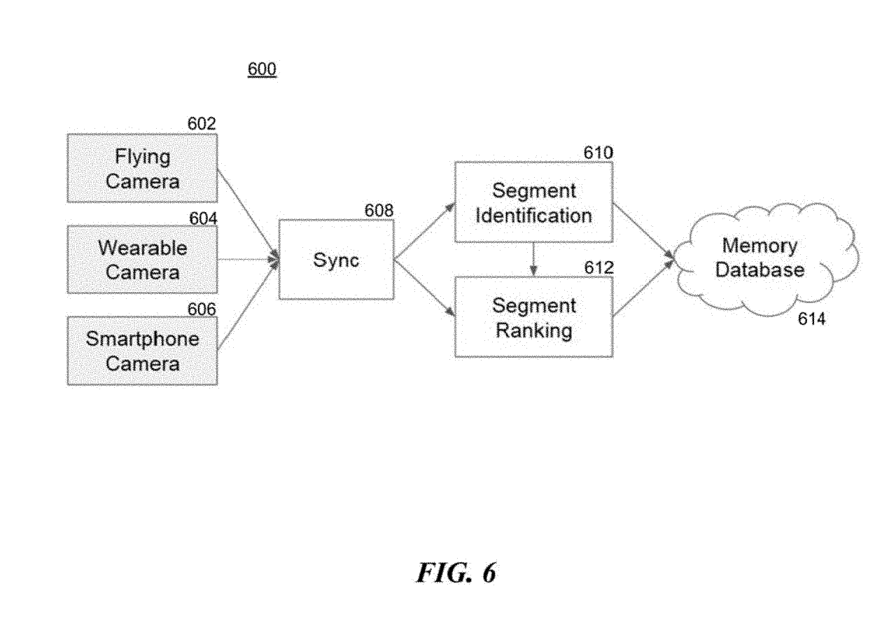

FIG. 6 depicts one example of a process 600 for automatically producing media content (e.g., a video composition) using inputs from several distinct computing devices, in accordance with various embodiments. More specifically, data can be uploaded (e.g., to a network-accessible platform or some other computing device) by a flying camera 602 (e.g., a UAV copter), a wearable camera 604 (e.g., an action camera), and/or a smartphone camera 606. The video/image/audio data uploaded by these computing devices may also be accompanied by other data (e.g., sensor data).

In some embodiments, the video/image data uploaded by these computing devices is also synced (step 608). That is, the video/image/audio data uploaded by each source may be temporally aligned (e.g., along a timeline) so that interesting segments of media can be more intelligently cropped and mixed. Temporal alignment permits the identification of interesting segments of a media stream when matched with secondary sensor data streams. Temporal alignment (which may be accomplished by timestamps or tags) may also be utilized in the presentation-time composition of a story. For example, a computing device may compose a story by combining images or video from non-aligned times of a physical location (e.g., as defined by GPS coordinates). However, the computing device may also generate a story based on other videos or photos that are time-aligned, which may be of interest to, or related to, the viewer (e.g., a story that depicts what each member of a family might have been doing within a specific time window).

The remainder of the process 600 may be similar to process 500 of FIG. 5 (e.g., steps 610 and 612 may be substantially similar to steps 512 and 514 of FIG. 5). Note, however, that in some embodiments multiple versions of the video composition may be produced. For example, a high resolution version may be saved to a memory database 614, while a low resolution version may be saved to a temporary storage for uploading to social media (e.g., Facebook, Instagram, or YouTube). The high resolution version may be saved in a location (e.g., a file folder) that also includes some or all of the source material used to create the video composition, such as the video/image/audio data uploaded by the flying camera 602, the wearable camera 604, and/or the smartphone camera 606.

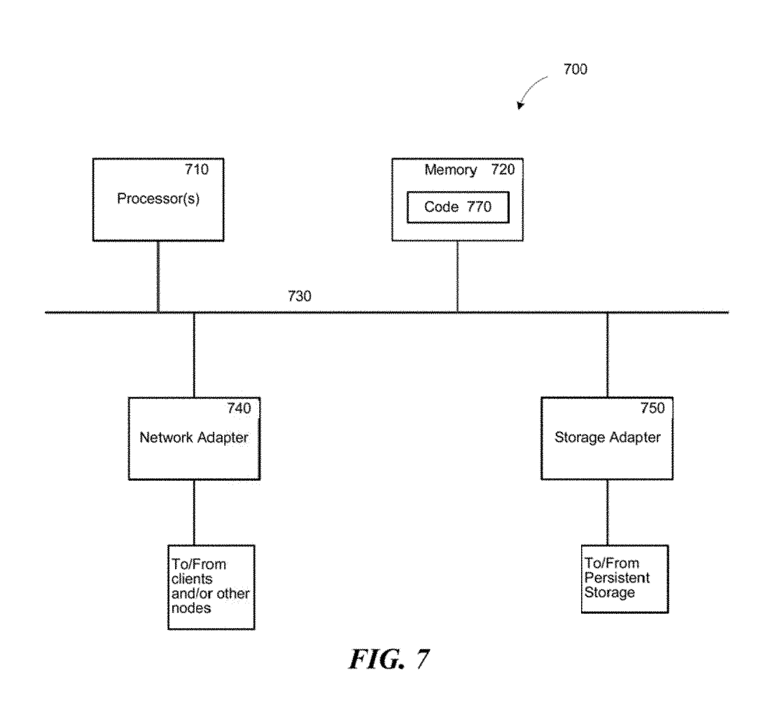

FIG. 7 is a block diagram of an example of a computing device 700, which may represent one or more computing device or server described herein, in accordance with various embodiments. The computing device 700 can represent one of the computers implementing the network-accessible platform 100 of FIG. 1. The computing device 700 includes one or more processors 710 and memory 720 coupled to an interconnect 730. The interconnect 730 shown in FIG. 7 is an abstraction that represents any one or more separate physical buses, point-to-point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The processor(s) 710 is/are the central processing unit (CPU) of the computing device 700 and thus controls the overall operation of the computing device 700. In certain embodiments, the processor(s) 710 accomplishes this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 720 is or includes the main memory of the computing device 700. The memory 720 represents any form of random access memory (RAM), read-only memory (ROM), flash memory, or the like, or a combination of such devices. In use, the memory 720 may contain a code 770 containing instructions according to the mesh connection system disclosed herein.

Also connected to the processor(s) 710 through the interconnect 730 are a network adapter 740 and a storage adapter 750. The network adapter 740 provides the computing device 700 with the ability to communicate with remote devices, over a network and may be, for example, an Ethernet adapter or Fibre Channel (FC) adapter. The network adapter 740 may also provide the computing device 700 with the ability to communicate with other computers. The storage adapter 750 allows the computing device 700 to access a persistent storage, and may be, for example, a Fibre Channel (FC) adapter or SCSI adapter.

The code 770 stored in memory 720 may be implemented as software and/or firmware to program the processor(s) 710 to carry out actions described above. In certain embodiments, such software or firmware may be initially provided to the computing device 700 by downloading it from a remote system through the computing device 700 (e.g., via network adapter 740).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

Reference in this specification to “various embodiments” or “some embodiments” means that a particular feature, structure, or characteristic described in connection with the embodiment is included in at least one embodiment of the disclosure. Alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments.

What is claimed is:

1. A method of producing a video composition from raw video recorded by a filming device, the method comprising:
receiving the raw video from the filming device;
receiving a raw log of sensor data from the filming device, an operator device, or some other computing device in proximity to the filming device;
parsing the raw log of sensor data to identify sensor reading variations that are indicative of interesting real-world events experienced by a user of the filming device;
identifying raw video segments that correspond to the identified sensor reading variations; and
automatically forming a video composition by combining and editing the raw video segments.

2. The method of claim 1, wherein said automatically forming the video composition is performed in accordance with a composition recipe.

3. The method of claim 1, wherein the filming device is an action camera, an unmanned aerial vehicle (UAV) copter, a mobile phone, or a camcorder.

4. The method of claim 1, further comprising:
presenting a user interface on an editing device associated with an editor; and
enabling the editor to manually modify the video composition.

5. The method of claim 4, wherein the editor is the user of the filming device.

6. The method of claim 4, further comprising:
in response to determining the editor has manually modified the video composition,
applying machine learning techniques to identify modifications made by the editor, and
based on the identified modifications, improving one or more algorithms that are used to identify interesting real-world events from the raw log of sensor data.

7. The method of claim 4, further comprising:
downscaling a resolution of the video composition; and
posting the video composition to a social media channel responsive to receiving input at the user interface that is indicative of a request to post the video composition to the social media channel.

8. The method of claim 1, wherein the raw log of sensor data is generated by an accelerometer, gyroscope, magnetometer, barometer, global positioning system (GPS) module, inertial module, or some combination thereof.

9. The method of claim 2, further comprising:
adding audio content to the video composition that conforms with an intended mood or style specified by the composition recipe.

10. A method comprising:
receiving raw video from a first computing device;
receiving a raw log of sensor data from a second computing device, wherein the raw log of sensor data is generated by a sensor of the second computing device;
parsing the raw log of sensor data to identify sensor measurements that are indicative of interesting real-world events; and
identifying raw video segments that correspond to the identified sensor measurements.

11. The method of claim 10, further comprising:
automatically forming a video composition by combining the raw video segments.

12. The method of claim 11, wherein the raw video segments are combined based on chronology or interest level, which is determined based on various combinations of the sensor measurements including, but not limited to, magnitude.

13. The method of claim 10, further comprising:
creating a video composition template that includes the raw video segments;
storing the video composition template to delay composition of a video composition from the video composition template until presentation to a viewer; and
before composing the video composition from the video composition template, personalizing the video composition for the viewer based on metadata or a viewer characteristic derived from social media.

14. The method of claim 10, wherein said parsing comprises:
examining the raw log of sensor data to detect sensor reading variations that exceed a certain threshold during a specified time period; and
flagging the sensor reading variations as representing interesting real-world events.

15. The method of claim 10, wherein the first computing device is an action camera, an unmanned aerial vehicle (UAV) copter, or a camcorder, and wherein the second computing device is an operating device for controlling the first computing device or a personal computing device associated with a user of the first computing device.

16. A non-transitory computer-readable storage medium comprising:
executable instructions that, when executed by a processor, are operable to:
receive raw video from a filming device;
receive a raw log of sensor data from the filming device, an operator device for controlling the filming device, or some other computing device in proximity to the filming device,
wherein the raw log of sensor data is generated by an accelerometer, gyroscope, magnetometer, barometer, global positioning system (GPS) module, or inertial module housed within the filming device;
parse the raw log of sensor data to identify sensor measurements that are indicative of interesting real-world events;
identify raw video segments that correspond to the identified sensor measurements; and
automatically form a video composition by combining the raw video segments.

17. The non-transitory computer-readable storage medium of claim 16, wherein the executable instructions are further operable to:
create a user interface that allows an editor to review the video composition.

18. The non-transitory computer-readable storage medium of claim 17, wherein the executable instructions are further operable to:
downscale a resolution of the video composition; and
post a downscaled version of the video composition to a social media channel responsive to receiving input at the user interface that is indicative of a request to post the video composition to the social media channel.

19. The non-transitory computer-readable storage medium of claim 16, wherein the executable instructions are further operable to:
save the video composition to a memory database.
